(19) United States
(12) Patent Application Publication
(10) Pub. No.: US 2008/0191833 A1
(43) Pub. Date: Aug. 14, 2008

(54) Thermal Protection For Electrical Installations and Fittings

(75) Inventor: David William Heathcote, Gloucester (GB)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: CALLSMART UK LIMITED, Gloucester (GB)

(21) Appl. No.: 11/915,539

(22) PCT Filed: May 25, 2006
(86) PCT No.: PCT/GB2006/001927

§ 371 Date: Nov. 26, 2007

(30) Foreign Application Priority Data
May 25, 2005 (GB) 0510613.3
Sep. 6, 2005 (GB) 0518056.7
Mar. 2, 2006 (GB) 0604160.2

(51) Int. Cl. H01H 37/00

(52) U.S. Cl. 337/298

(57) ABSTRACT

An electrical fitting such as a socket (1) is provided with a thermal cut-out (16) to disconnect the power supply to the socket (1) in response to detection of an abnormal increase in temperature caused, for example, by a loose or faulty connection. The cut-out (16) is connected across the earth and neutral terminals and is normally open and is closed when an abnormal temperature is detected to cause a fault that trips a residual current detector (RCD) to disconnect the power supply to the socket (1). The cut out (16) may be a switch (17) operable by a temperature responsive actuator (18). In one embodiment (FIG. 4), the cut-out comprises contacts held apart (open circuit) by a thermally responsive spacer that melts at a predetermined temperature to allow the contacts to come together (closed circuit) to trigger the RCD (FIGS. 4 and 5).

This invention concerns improvements in or relating to electrical installations and parts and fittings for such installations. In particular, but not exclusively, the invention concerns fittings having at least one electrical termination/contact such as sockets, switches, junction boxes, consumer units and the like for domestic, commercial and industrial applications. The invention also concerns parts for such fittings that are responsive to temperature change to cause an interruption to the power supply.

Build-up of heat at electrical connections such as wiring terminations and switch contacts is a common cause of electrical fires in buildings. Terminations within an electrical installation are more likely to become overheated than the transmission wiring. In particular, a pin of a plug, the plug pin position in a socket, or the contacts of a switch are vulnerable to overheating for a variety of reasons. For example, installers may fail to tighten to the screws securing the cable or fail to prepare properly the tails of the cable causing the connection to produce heat which back-tracks along the cable core burning the PVC insulation. If no fire is produced then, the burned insulation is carbonised and becomes a conductor rather than an insulator. As a result, a resistance is formed and the damaged cable becomes a crude heating element creating a further rise in temperature until a fire breaks out.

RCD's (residual current detector) are commonly employed to protect an installation where a fault occurs in a circuit. An RCD protected circuit considers it acceptable for a resistance to exist and the RCD is unlikely therefore to be tripped by the above action unless the earth conductor is involved (where fitted). The RCD is also unlikely to be tripped by any current overload provided it is within the generated current consumption of the installation.

The present invention has been made from a consideration of the foregoing problems. It is a preferred object of the present invention to provide a thermal protection device that provides a solution to the problem of electrical fires caused by overheating of electrical terminations/contacts or the like

According to a first aspect of the present invention, there is provided in or for an electrical installation, sensor means for monitoring the temperature of at least one electrical termination/contact and interrupting power to the termination/contact when a pre-determined temperature is detected.

The present invention detects when a build-up of heat occurs at a termination/contact for any reason such as a faulty connection and interrupts the power supply before a fire occurs.

The sensor means may comprise a device for detecting change in temperature of the monitored termination/contact, for example a bimetal strip, thermocouple or the like, and actuating a cut-out to interrupt the power supply when a pre-determined temperature is detected.

Where the installation includes an RCD (residual current detector), the sensor means may be arranged to trip the RCD in response to detection of the pre-determined temperature. For example, the sensor means may include a switch connected across two terminals of the RCD that is normally open and is closed when the pre-determined temperature is detected to generate a fault that trips the RCD to interrupt the power supply. Typically, the terminals are earth and neutral which, being of extremely low or no potential, are harmless in themselves. With this arrangement, the RCD prevents re-connection of the power supply until the fault has been corrected.

Preferably, the sensor means is provided in an electrical fitting employing the termination/contact that is being monitored. For example, the sensor means may be provided to monitor the temperature of the plug pins/pin receiving contacts of an outlet socket or the temperature of the contacts of a switch. The sensor means may be arranged to monitor the temperature of a plurality of terminations/contacts within the same fitting.

According to a second aspect of the present invention, there is provided an electrical fitting having at least one termination/contact and sensor means for monitoring the temperature of the termination/contact and causing the power supply to the fitting to be interrupted when a pre-determined temperature is detected.

The electrical fitting may be a socket, switch, junction box, consumer unit or any other fitting in which there is a termination/contact that may generate heat.

According to a third aspect of the present invention, there is provided a method of protecting an electrical installation or fitting by monitoring the temperature of one or more terminations/contacts and interrupting the power supply when a pre-determined temperature is detected.

According to a fourth aspect of the present invention, there is provided a thermal protection device comprising first and second electrically conducting terminals configured such that the device is non-conducting in a first state, and conducting in a second state in response to detection of a pre-determined temperature.

The conducting terminals may be prevented from contacting each other in the first state and allowed to contact in the second state. For example, the terminals may be spaced apart in the first state and be relatively movable to contact each other in the second state. Alternatively, the terminals may be spaced apart in both the first and second states and means provided for making electrical contact between the terminals in the second state.

The invented device detects when a build-up of heat occurs for any reason such as a faulty electrical connection and the change of state from non-conducting to conducting can be used to interrupt the power supply before a fire occurs. For example, the device may be arranged to trip an RCD (residual current detector), in response to detection of a pre-determined temperature. Thus, the terminals may be connected to earth and neutral conductors or earth and live conductors to generate a fault when the terminals contact that trips the RCD to interrupt the power supply. With this arrangement, the RCD prevents re-connection of the power supply until the fault has been corrected.

Preferably, the device is provided in an electrical fitting employing connections that may give rise to an increase in temperature if the connections are or become loose or faulty. For example, the device may be provided in an electrical plug, socket or switch to detect an increase in temperature caused by a loose/faulty connection.

According to a fifth aspect of the present invention, there is provided a thermal protection device comprising first and second electrically conducting terminals separated by an electrically insulating spacer responsive to change in temperature such that the device is non-conducting in a first state when the terminals are separated and conducting in a second state when the terminals contact.

The invented device detects when a build-up of heat occurs for any reason such as a faulty electrical connection and the change of state from non-conducting to conducting can be used to interrupt the power supply before a fire occurs. For example, the device may be arranged to trip an RCD (residual current detector), in response to detection of a pre-determined temperature. Thus, the terminals may be connected to earth and neutral conductors or earth and live conductors to generate a fault when the terminals contact that trips the RCD to interrupt the power supply. With this arrangement, the RCD prevents re-connection of the power supply until the fault has been corrected.

Preferably, the device is provided in an electrical fitting employing connections that may give rise to an increase in temperature if the connections are or become loose or faulty. For example, the device may be provided in an electrical plug, socket or switch to detect an increase in temperature caused by a loose/faulty connection.

Preferably, the electrically insulating spacer is made of a material that melts at the pre-determined temperature to allow the first and second terminals to contact each other and change the device from the first, non-conducting state to the second, conducting state. For example, the spacer may be made of wax. The composition of the material forming the spacer may be adjusted to alter the temperature at which the spacer melts according to the requirements for any given application.

Preferably, the device cannot be re-set after it has changed state. In this way, the power supply cannot be re-connected until the device has been replaced. Where the device is employed in an electrical fitting, it may be an integral, permanent component of the fitting such that the power supply cannot be re-connected when the device has changed state until the fitting is replaced.

According to a sixth aspect of the present invention, there is provided an electrical fitting provided with a thermal protection device for causing the power supply to the fitting to be interrupted when a pre-determined temperature is detected.

The electrical fitting may be a socket, switch, junction box, consumer unit or any other fitting in which heat may be generated by a faulty/loose electrical termination/connection.

The thermal protection device may change state when the pre-determined temperature is detected and be non-resettable to prevent the power supply being re-connected until the device has been replaced. The device may be an integral, permanent part of the fitting such that the fitting must be replaced before the power supply can be reconnected.

According to a seventh aspect of the present invention, there is provided a method of protecting an electrical installation or fitting by providing a thermal protection device operable to change state when a pre-determined temperature is detected and cause the power supply to be interrupted.

The invention will now be described in more detail by way of example only with reference to the accompanying drawings wherein:

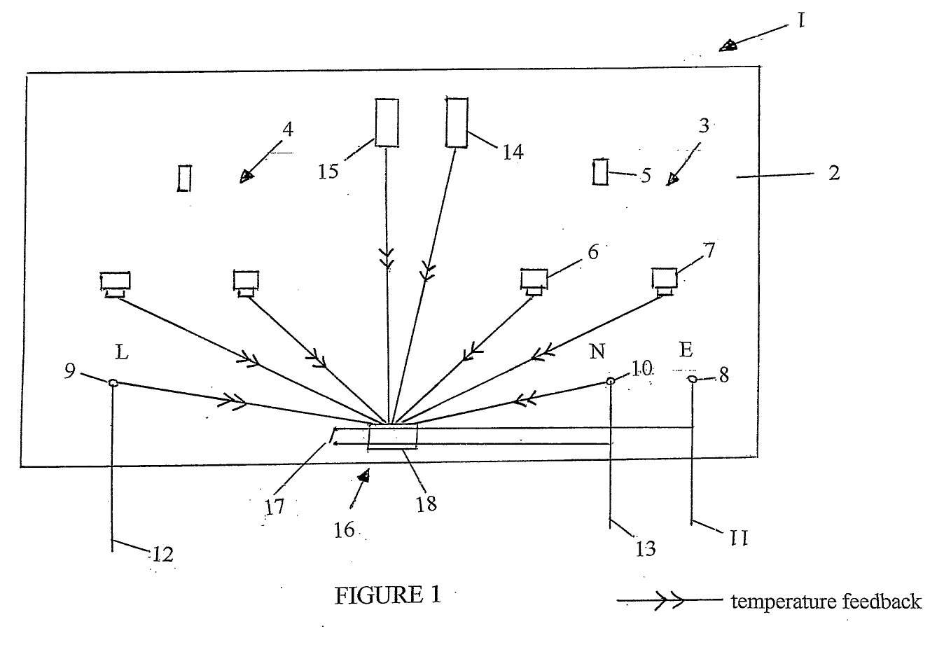

FIG. 1 shows a first embodiment of the invention applied to a double socket;

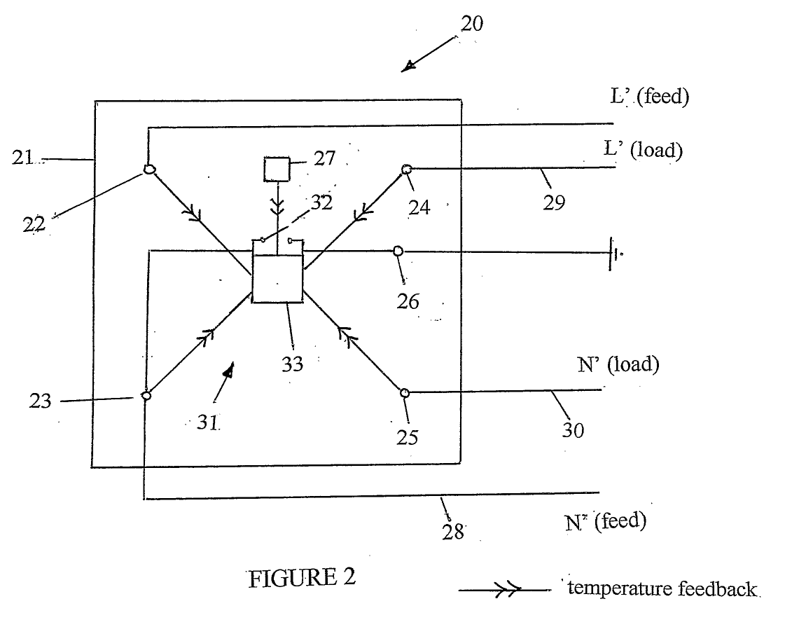

FIG. 2 shows a second embodiment of the invention applied to a shower pull switch;

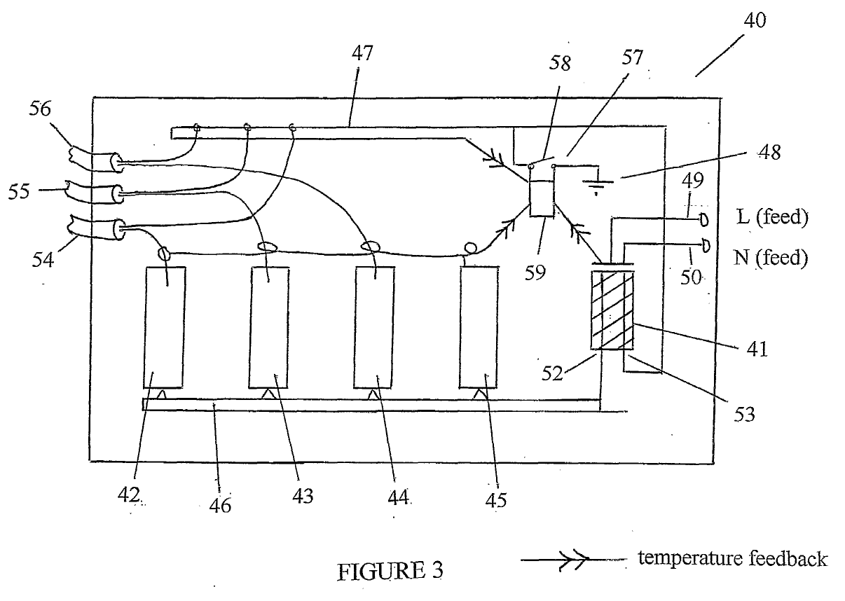

FIG. 3 shows a third embodiment of the invention applied to a consumer unit;

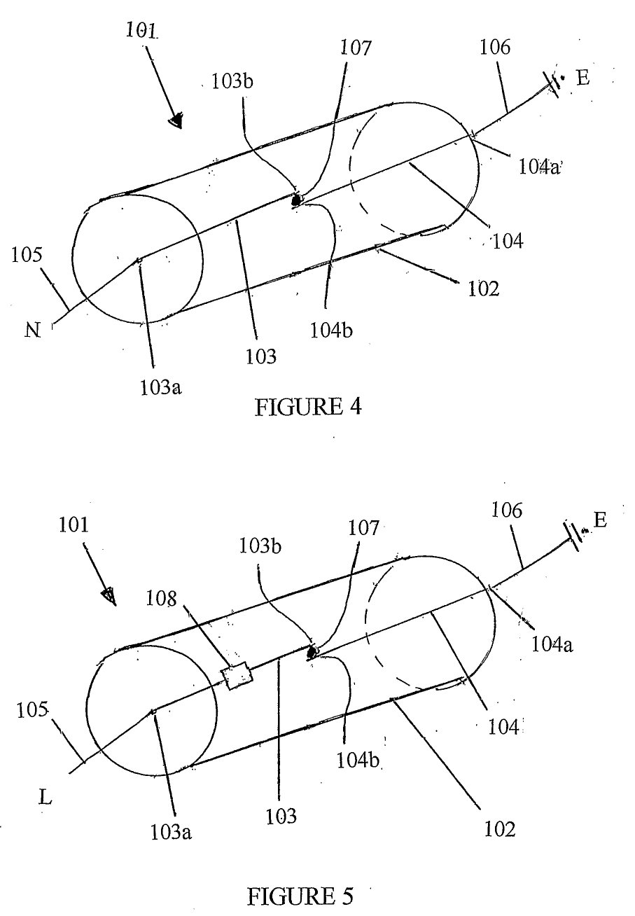

FIG. 4 shows a thermal protection device according to the invention;

FIG. 5 shows a modification to the thermal protection device of FIG. 4; and

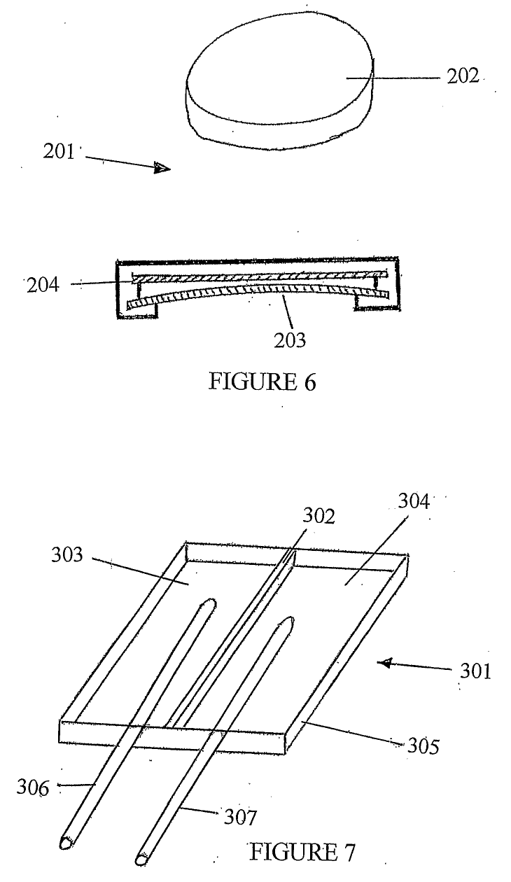

FIGS. 6 to 10 show alternative thermal protection devices according to the invention.

Referring first to FIG. 1, an electrical socket 1 is shown having a faceplate 2 provided with two outlets 3,4 each having pin receiving terminals 5,6,7 configured to receive the pins of a three pin plug (not shown). In known manner, the terminals 5,6,7 are designated ground/earth, live and neutral respectively and the faceplate 2 is provided with inlet terminals 8,9,10 for connection to ground/earth, live and neutral wires 11,12,13 of a power supply cable, for example by clamping the wires to the terminals with screws (not shown). In this embodiment, the faceplate 2 is provided with a respective switch 14,15 for each outlet 3,4 to connect/disconnect the pin receiving terminals 5,6,7 to/from the inlet terminals 8,9,10. This is not essential, however, and the switches 14,15 may be omitted. The faceplate 2 may also be provided with a respective shutter (not shown) for each outlet 3,4 that prevents/restricts access to the pin receiving terminals 5,6,7 when there is no plug in the outlet 3,4 and is retracted on insertion of the plug pins.

In accordance with the present invention, the socket 1 is provided with a thermal cut-out 16 to disconnect the power supply to the socket 1 in response to detection of an abnormal increase in temperature such as may be caused by a loose/faulty connection to the inlet terminals 8,9,10 and/or to the pins of a plug connected to the pin receiving terminals 5,6,7 and/or by a loose/faulty contact between the plug pins and the pin receiving contacts 5,6,7 and/or by a loose/faulty switch contact. As shown, the thermal cut-out 16 includes a switch 17 across the earth and neutral terminals that is normally open and is closed when an abnormal temperature is detected to cause a fault that trips an RCD (residual current detector) or similar device to disconnect the power supply to the socket 1. The switch 17 is operable by a temperature responsive actuator 18 arranged to sense the temperature of the live and neutral inlet terminals 9,10, the live and neutral pin receiving terminals 6,7, and the switches 14,15. The actuator 18 may be of any suitable type that closes the switch 17 if an abnormal increase in temperature is detected. Temperature feedback to the actuator 18 from the terminations/contacts may be provided by any suitable means. In this way, the risk of a fire being caused by a loose/faulty electrical connection/contact in the socket 1 is reduced or eliminated.

Referring now to FIG. 2, a double pole switch 20 of the type commonly used to connect an appliance such as an electric shower unit (not shown) to a power supply is shown having a switch plate 21 provided with inlet terminals 22,23 designated live and neutral, outlet terminals 24,25 designated live and neutral, and a common earth terminal 26. An incoming power supply cable has live and neutral wires 27,28 connected to the inlet terminals 22,23 and a cable from an appliance such as an electric shower unit has live and neutral wires 29,30 connected to the outlet terminals 24,25. Both cables are also connected to the earth terminal 26. A switch 27 operable by a pull cord or the like is also provided to connect/disconnect the inlet terminals 22,23 to/from the outlet terminals 24,25 to connect/disconnect the power supply to the appliance.

In accordance with the present invention, the switch 20 is provided with a thermal cut-out 31 to disconnect the power supply to the switch 20 in response to detection of an abnormal increase in temperature such as may be caused by a loose/faulty connection to the inlet terminals 22,23 and/or the outlet terminals 24,25 and/or by a loose/faulty contact in the pull switch 27. As shown, the thermal cut-out 31 includes a switch 32 across the earth terminal 26 and neutral inlet terminal 23. The switch 32 is normally open and is closed when an abnormal temperature is detected to cause a fault that trips an RCD (residual current detector) or similar device to disconnect the power supply to the switch 20. The switch 32 is operable by a temperature responsive actuator 33 arranged to sense the temperature of the live and neutral terminals 22,23,24,25 and the pull switch 27. The actuator 33 may be of any suitable type that closes the switch 32 if an abnormal increase in temperature is detected. Temperature feedback to the actuator 33 from the terminations/contacts may be provided by any suitable means. In this way, the risk of a fire being caused by a loose/faulty electrical connection/contact in the switch 20 is reduced or eliminated.

With reference now to FIG. 3, a consumer unit 40 of the type commonly used to connect a power supply input to a plurality of outputs. The outputs may be a ring main circuit for socket or lighting or any other purpose. The unit 40 has an RCD (residual current detector) 41, a plurality of MCB's (miniature circuit breakers) 42,43,44,45, a live bus bar 46, a neutral bus bar 47 and a common earth/ground terminal 48.

The RCD 41 has inlet terminals connected to live and neutral wires 49,50 of an incoming power supply cable and outlet terminals 52,53 connected to the live and neutral bus bars 46,47 respectively. A plurality of outlet cables 54,55,56 are provided for different circuits such as sockets, lighting, cooker etc. Each cable 54,55,56 has a live wire connected to the live bus bar 46 via a respective MCB 42,43,44 and a neutral wire connected to the neutral bus bar 47. Each cable also 54,55,56 has an earth wire (not shown) connected to the earth terminal 48.

In accordance with the present invention, the unit 40 is provided with a thermal cut-out 57 to disconnect the power supply to the MCB's 42,43,44,45 in response to detection of an abnormal increase in temperature such as may be caused by a loose/faulty connection in the unit 40. As shown, the thermal cut-out 57 includes a switch 58 across the earth terminal 48 and neutral bus bar 47. The switch 58 is normally open and is closed when an abnormal temperature is detected to cause a fault that trips the RCD 41 to disconnect the power supply to the MCB's 42,43,44,45. The switch 58 is operable by a temperature responsive actuator 59 arranged to sense the temperature of the various connections and contacts in the unit 40 and close the switch 58 if an abnormal increase in temperature is detected. Temperature feedback to the actuator 59 from the terminations/contacts may be provided by any suitable means. In this way, the risk of a fire being caused by a loose/faulty electrical connection/contact in the consumer unit 40 is reduced or eliminated.

As will be appreciated, the embodiments of FIGS. 1 to 3 provide a solution to the problem of electrical fires caused by heat build-up in an electrical installation/fitting by monitoring the temperature of terminations/contacts where heat may be generated and interrupting the power supply when an increase in temperature is detected that could lead to outbreak of a fire. Typically, the power supply is interrupted when a pre-determined temperature higher than ambient is detected.

Referring now to FIG. 4, a thermal protection device 101 is shown capable of detecting when a build-up of heat occurs such as from a faulty electrical connection and causing the power supply to be interrupted before a fire occurs. The device 101 could be used in place of the thermal cut-out devices described in the previous embodiments to protect the parts and fittings described.

The device 101 comprises a tubular housing 102 of cylindrical shape containing first and second electrically conducting internal terminals 103,104. It will be understood that the size and shape of the housing may be changed to suit the application of the device 101.

The outer ends 103a,104a of the terminals 103,104 are connectable to electrical lines 105,106 respectively. The inner ends 103b,104b of the terminals are arranged opposite each other and are separated by an electrically insulating spacer 107. In this embodiment, the terminals 103,104 are flat strips of metal and the spacer 107 is a plug of wax or other thermally responsive material positioned between the strips at the inner ends 103b,104b of the terminals 103,104. It will be understood that the terminals 103,1004 and/or spacer 107 may be made of any suitable materials.

In use, the spacer 107 prevents the inner ends 103b,104b of the terminals 103,104 coming into contact below a pre-determined temperature at which the wax or other material from which the spacer 107 is formed is a solid. In this condition, the device 101 is “open” circuit and the lines 105,106 are isolated from each other. At the pre-determined temperature, the spacer 107 melts allowing the inner ends 103b,104b of the terminals 103,104 to come into contact and the device 101 changes to “closed” circuit in which the lines 105,106 are connected.

One or both of the terminals 103,104 may be constructed and/or arranged so that the inner ends 103b,104b are kept apart by the spacer 107 against a biasing force that acts on one or both ends 103b,104b and ensures the ends 103b,104b contact each other when the spacer 107 melts. For example, where the terminals 103,104 are metal strips, one or both strips may be arranged so that the inner end 103b,104b is deflected when the spacer 107 is located therebetween to create a biasing force that ensures the inner ends 103b,104b contact each other when the spacer 107 melts.

The device 101 may be installed in an electrical circuit such as in the parts and fittings shown in FIGS. 1 to 3 with the terminals 103,104 connected to earth and neutral lines respectively such that the earth and neutral lines are isolated when the device 101 is “open” circuit and are connected when the device 101 is “closed” circuit to cause a fault that trips an RCD (residual current detector) or similar device to disconnect the power supply to the circuit. In this way, the RCD is tripped when the spacer 107 melts. The pre-determined temperature at which the spacer 107 melts can be chosen according to the location and application of the device 101 by appropriate selection of the material from which the spacer 107 is made.

The increase in temperature required to cause the spacer 107 to melt and trigger the RCD may be the result of a loose/faulty connection in the circuit in which the device 101 is installed and may be chosen to interrupt the power supply before a temperature is reach that could give rise to a fire. For example, the device 101 may be provided in an electrical fitting such as a plug, socket or switch (not shown) to detect an increase in temperature resulting from a loose/faulty connection to the inlet terminals and/or to the pins of a plug connected to the pin receiving terminals and/or by a loose/faulty contact between the plug pins and the pin receiving contacts and/or by a loose/faulty switch contact. In this way, the risk of a fire being caused by a loose/faulty electrical connection/contact in the fitting is reduced or eliminated.

Once the spacer 107 has melted to change the device 101 from “open” circuit to “closed” circuit, the device 101 cannot be re-set and therefore the RCD cannot be re-set to re-connect the power supply until the device 101 has been identified and replaced. In one arrangement, the device 101 may be an integral, permanent component of the fitting so that, the fitting itself must be identified and replaced in order to re-set the RCD for the circuit in which the fitting is connected. In another arrangement, the device 101 may be a separate, detachable component of the fitting so the device 101 can be replaced. The wax spacer 107 may be replaced by any other suitable means that maintains the device “open” circuit up to a pre-determined temperature at which the device changes state to become “closed” circuit and cause the power supply to be interrupted. For example, one or both terminals 103,104 may be configured to be spaced apart up to a pre-determined temperature in which the device is “open” circuit and to come into contact at or above the pre-determined temperature to change the state of the device to become “closed” circuit.

Referring now to FIG. 5, a modification to the device 101 of FIG. 4 is shown in which the terminals 103,104 are connected to earth and live lines respectively such that the earth and live lines are isolated when the device 101 is “open” circuit and are connected when the device 101 is “closed” circuit to cause a fault that trips an RCD (residual current detector) or similar device to disconnect the power supply to the circuit. In this way, the RCD is tripped when the spacer 107 melts. A direct connection from earth to live would normally be considered unsuitable as it would constitute a dangerous short. However, the incorporation of a resistor 108 or another limiter in series with device 101 as shown in FIG. 5 would overcome this problem and provide a safe alternative to the arrangement of the device 101 shown in FIG. 4. The resistor/limiter 108 could be provided within the same housing 102 or provided separately and connected to the device during manufacture of the part or fitting to incorporate the device 101.

In the case of application of the device 101 to 3 phase supplies, any one or all of the 3 “lives” should be covered.

In all of the above-described embodiments, the power supply is interrupted by an RCD (residual current detector) but it will be understood that any other device could be employed to interrupt the power supply. The RCD (residual current detector) or other device may protect an installation or circuit containing a plurality of fittings each provided with a temperature sensor or may be built-into a fitting with the temperature sensor. Furthermore, it will be understood that the temperature sensor for monitoring the temperature of the terminations/contacts where heat may be generated can comprise the device 101 of FIGS. 4 and 5 or any other suitable device such as shown in FIGS. 6 to 10.

FIG. 6 shows a “popper disc” device 201 having a rigid moulded body 202 of bakelite or other suitable material. The body 202 is of channel section housing a metal or bi-metal convex disc 203 and a fixed metal plate 204 to which electrical conductors (not shown) are connected. Disc 203 is normally spaced from the plate 204 to provide a break between the electrical connections and expands in response to temperature increase until it contacts plate 204 to make an electrical connection between the conductors. This can be used in turn to trip an RCD. Expansion of disc 203 may deform permanently the disc so that the device cannot be re-set.

FIG. 7 shows a “tab” device 301 in which a bridge 302 of wax or other suitable material separates liquid reservoirs 303 and 304 within a container 305 having a lid (not shown) to seal the reservoirs 303,304. Conductors 306,307 are in contact with the liquid in the reservoirs 303,304 respectively. The wax bridge 302 melts in response to temperature increase allowing the liquid in the reservoirs 303,304 to come into contact. The liquid is electrically conducting and provide an electrical connection between the conductors 306,307. This can be used in turn to trip an RCD. The wax bridge 302 is permanently broken so that the device cannot be re-set.

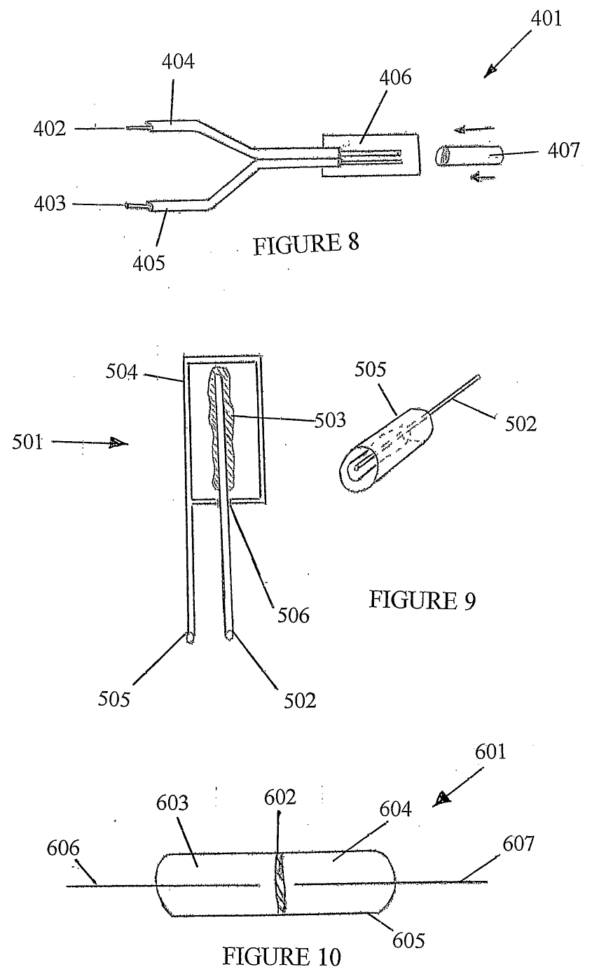

FIG. 8 shows a “probe” device 401 in which the ends of the conductors 402,403 having insulation sleeves 404,405 are exposed within a housing 406 and surrounded by a sleeve 407 of heat shrinkable material that is a push-fit over the exposed ends of the conductors 402,403. The exposed ends of the conductors 403,403 are normally spaced apart to provide a break between the electrical conductors and the sleeve 407 shrinks in response to temperature increase to bring the exposed ends of the conductors 402,403 together to make an electrical connection between the conductors 402,403. This can be used in turn to trip an RCD. The exposed ends of the conductors 402,403 may deform permanently when the sleeve 407 shrinks so that the device cannot be re-set.

FIG. 9 shows a “solder” device 501 in which the end of an electrical conductor 502 is surrounded by solder 503 in a hollow metal chamber 504 to which a conductor 505 is connected. The conductor 502 is insulated at 506 where it passes through the wall of the chamber 504. The solder 503 melts in response to temperature increase and comes into contact with the wall of the chamber 504 to provide an electrical connection between the conductors 502,505. This can be used in turn to trip an RCD. The solder 503 provides a permanent connection so that the device cannot be re-set.

FIG. 10 shows a “capsule” device 601 in which a bridge 602 of wax or other suitable material separates reservoirs 603,604 within a housing 605 of glass, ceramic or other suitable material. The reservoirs 603,604 contain a liquid and conductors 606,607 are arranged to contact the liquid within the reservoirs 603,604 respectively. The wax bridge 602 melts in response to temperature increase allowing the liquid in the reservoirs 603,604 to come into contact. The liquid is electrically conducting and provides an electrical connection between the conductors 606,607. This can be used in turn to trip an RCD. The wax bridge 602 is permanently broken so that the device cannot be re-set.

It will be understood that each of the devices shown in FIGS. 6 to 10 undergoes a change of state from a non-conducting condition to a conducting condition in response to an increase in temperature and can be used in similar manner to the devices shown in FIGS. 4 and 5 to cause a power supply to be interrupted when a rise in temperature sufficient to cause the change of state occurs. Other methods for achieving this will be apparent to those skilled in the art.

Other modifications that can be made without departing from the principle or concept of the invention as described herein will be apparent to those skilled in the art and it will be understood that the above-described embodiments are merely illustrative of the invention and that the invention is capable of application to other electrical installations and fittings to reduce the risk of outbreak of a fire. The application of the device 101 is not limited to the electrical fittings described and has wider application to electrical installations where it is desirable to interrupt a power supply in response to an abnormal increase in temperature.

1-27. (canceled)

28. A thermal protection device comprising first and second electrically conducting terminals configured such that the device is non-conducting in a first state in which the terminals are prevented from contacting, and conducting in a second state when the terminals contact in response to detection of a pre-determined temperature, wherein the terminals are separated by an electrically insulating spacer made of a material that melts at the pre-determined temperature such that, when the spacer melts, the first and second terminals contact each other under a biasing force and change the device from the first, non-conducting state to the second, conducting state.

29. A thermal protection device according to claim 28 characterised in that, the spacer is made of wax.

30. A thermal protection device according to claim 28 wherein, the device cannot be re-set after it has changed state.

31. A thermal protection device according to claim 28 wherein, the biasing force acts on at least one of the terminals.

32. A thermal protection device according to claim 28 wherein the terminals are connected to earth and neutral conductors or earth and live conductors to generate a fault when the terminals contact to trip an RCD (residual current detector) in response to detection of the pre-determined temperature to interrupt the power supply.

33. A thermal protection device according to claim 28 wherein, the device is provided in an electrical fitting to detect an increase in temperature if the connections are or become loose or faulty.

34. A thermal protection device according to claim 33 wherein the device is configured as an integral, permanent component of the fitting.

35. A thermal protection device according to claim 33 wherein the device is configured as a removable component of the fitting.

36. The combination of the thermal protection device according to claim 28 and an electrical fitting, wherein the thermal protection device causes a power supply to the fitting to be interrupted when a pre-determined temperature is detected.

37. The combination according to claim 36 wherein the electrical fitting is selected from the group comprising a socket, switch, junction box, and consumer unit.

38. The combination according to claim 36 wherein the thermal protection device permanently changes state when the pre-determined temperature is detected to prevent the power supply being re-connected until the device has been replaced.

39. An electrical installation having sensor means for monitoring the temperature of at least one electrical termination/contact and interrupting power to the termination/contact when a pre-determined temperature is detected.

40. An installation according to claim 39 characterised in that the sensor means comprises a device for detecting change in temperature of the monitored termination/contact and actuating a cut-out to interrupt the power supply when a pre-determined temperature is detected.

41. An installation according to claim 40 wherein the device is arranged to trip an RCD (residual current detector) in response to detection of a pre-determined temperature.

42. An installation according to claim 41 wherein the device comprises first and second electrically conducting terminals separated by an electrically insulating spacer responsive to change in temperature such that the device is non-conducting in a first state when the terminals are separated and conducting in a second state when the terminals contact, and wherein the spacer is made of a material that melts at the pre-determined temperature such that, when the spacer melts, the first and second terminals contact each other under a biasing force and change the device from the first, non-conducting state to the second, conducting state.

43. An installation according to claim 42 wherein one of the first and second terminals is connected to an earth conductor and the other terminal is connected to a neutral or live conductor to generate a fault when the first and second terminals contact that trips the RCD to interrupt the power supply.

44. An installation according to claim 41 wherein the sensor means includes a switch connected across two terminals of the RCD that is normally open and is closed when the pre-determined temperature is detected to generate a fault that trips the RCD to interrupt the power supply.

45. An installation according to claim 39 wherein, the sensor means is provided in an electrical fitting employing the termination/contact that is being monitored.

46. An installation according to claim 39 wherein the sensor means is arranged to monitor the temperature of a plurality of terminations/contacts within the same fitting.

47. A method of protecting an electrical installation or fitting by monitoring the temperature of one or more terminations/contacts and providing a thermal protection device operable to change state when a pre-determined temperature is detected and cause a power supply to the installation or fitting to be interrupted.
